(19) United States
(12) Patent Application Publication
(10) Pub. No.: US 2012/0090234 A1
(43) Pub. Date: Apr. 19, 2012

(54) Configurable Wall

(76) Inventor: Brian Cronin, Carmel, NY (US)

(21) Appl. No.: 13/269,530

(22) Filed: Oct. 7, 2011

Related U.S. Application Data
(60) Provisional application No. 61/392,585, filed on Oct. 13, 2010.

(51) Int. Cl. A01G 9/02; E04C 1/39; E04B 2/18; E04B 2/00

(52) U.S. Cl. 47/86; 52/745.2; 52/576; 52/578

(57) ABSTRACT

A configurable wall is disclosed. In an example, the configurable wall includes a first hollow-formed module having an outer layer selected to portray a material of manufacture which is substantially different than a material with which the first hollow-formed module is manufactured. The wall also includes a second hollow-formed module having an outer layer selected to compliment the outer layer of the first hollow-formed module. The wall also includes an interconnect to secure the first module and the second module together.

### PRIORITY CLAIM

This application claims priority to U.S. provisional patent application Ser. No. 61/392,585 filed on Oct. 13, 2010 and titled “Uni Pots” of Brian Cronin, and is hereby incorporated by reference for all that it discloses as if fully set forth herein.

### BACKGROUND

Homeowners, shop owners, and others may desire the look of a decorative masonry (e.g., stone or brick) wall, but do not want to incur the time or expense to have such a wall built. In addition to the expense, these walls are often permanent fixtures, and cannot be readily rearranged or easily moved to different locations on the property. For example, if the homeowner is using the wall as a planter box and growing plants in the wall, the plants may need to be moved inside during cold spells, and/or into/out of direct sunlight. Or for the example, the homeowner may not want the wall in the same location on the property all of the time. Indeed, it may be difficult and expensive to have the wall altogether removed if the homeowner no longer desires the wall on the property.

### BRIEF DESCRIPTION OF THE DRAWINGS

FIGS. 1 and 1a are perspective views of a configurable wall.

FIG. 2 shows example skins which may appear on a visible outer layer of the configurable wall.

FIG. 3 is a plan view of an example unassembled module used in the configurable wall.

FIG. 4a-b illustrate example assembly of adjacent modules to form the configurable wall.

FIG. 5 shows cross-sectional views of example interlocking members for assembling adjacent modules.

FIG. 6 is another illustration of assembly of adjacent modules to form the configurable wall.

FIG. 7 are side plan views showing example configurations of the configurable wall.

FIG. 8 are top plan views showing example configurations of the configurable wall.

### DETAILED DESCRIPTION

The configurable wall (e.g., for use as a planter) described herein provides consumers with an inexpensive and simple way to build and move a lightweight wall, while still creating the appearance of a brick, stone, or other type of wall. The configurable wall may include modules that connect or interlock with one another. The modules can be configured in a variety of different ways based on consumer preference, size constraints, and other design considerations. Indeed, the modules can be reconfigured over time.

It is noted that although in an example the modules can come unassembled and/or be later unassembled, in another example, the modules may come fully assembled for the end-user. It is also noted that the modules can be interlocked to form a “solid” wall that does not wobble and appears as a single unit after being interlocked with one another.

The configurable wall may be designed with a faux finish to give the appearance that flowers or plants have been planted in a brick, stone, or other type of wall. The faux finish may be three dimensional (e.g., to appear like actual stone or bricks), or may be a flat finish (e.g., giving a smooth marble or polished granite appearance). But unlike traditional walls, the modules can be arranged in different layouts and can also be readily moved in and out of direct sunlight or rain/snow, and/or to other locations, and assembled in different configurations.

Before continuing, it is noted that as used herein, the terms “includes” and “including” mean, but is not limited to, “includes” or “including” and “includes at least” or “including at least.” The term “based on” means “based on” and “based at least in part on.”

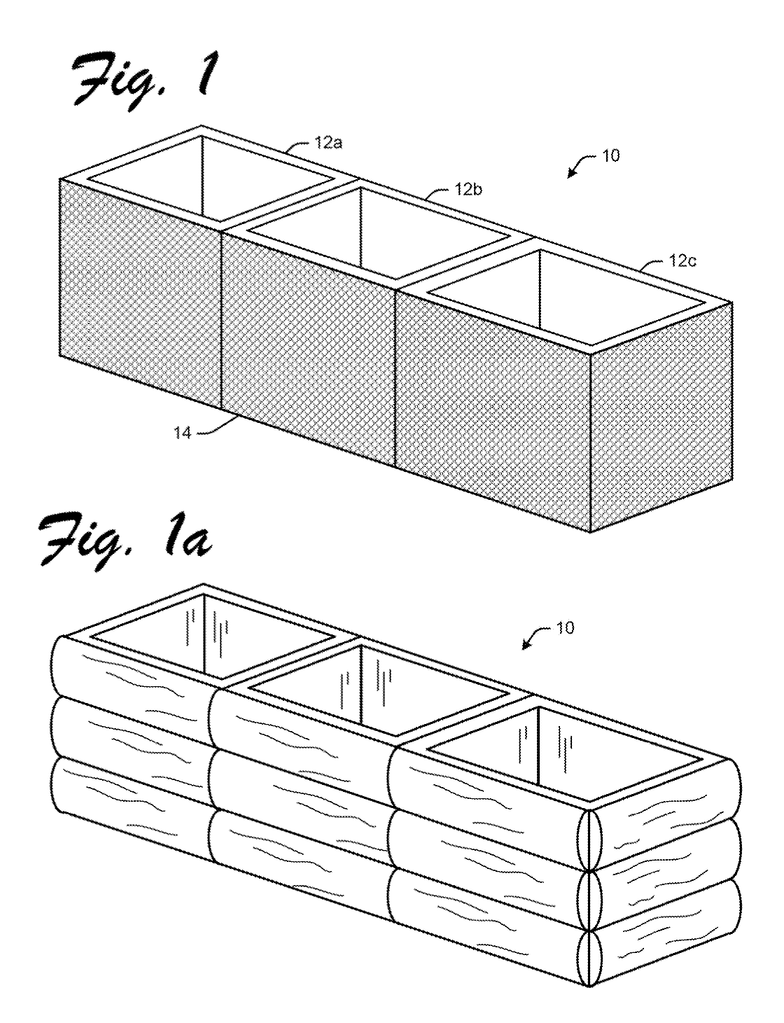

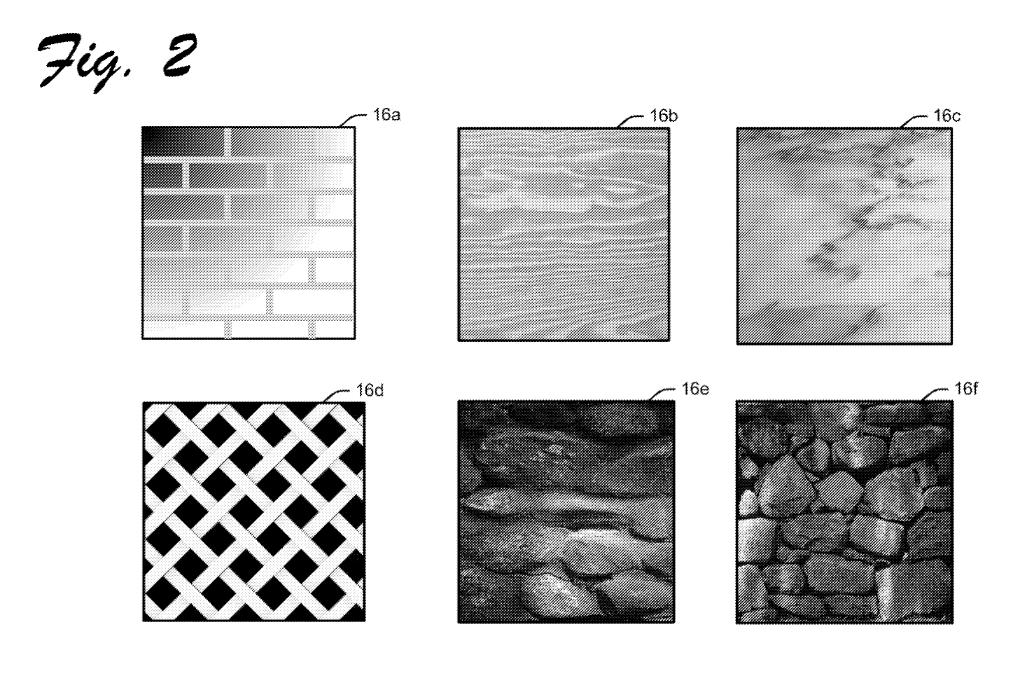

FIG. 1 is a perspective view of a configurable wall 10. FIG. 1 a shows the configurable wall 10 with a faux wood or log finish. In an example, the configurable wall 10 includes hollow-formed modules 12a-c. It is noted that the connections used to assemble the modules 12a-c and to assemble the wall 10 are not visible after assembly, as will become apparent from the later drawings illustrating assembly. The modules 12a-c may be made of plastic or other suitable material. But the modules 12a-c have an outer layer 14 selected to depict or portray a material of manufacture which is substantially different than a material with which the first hollow-formed module is manufactured.

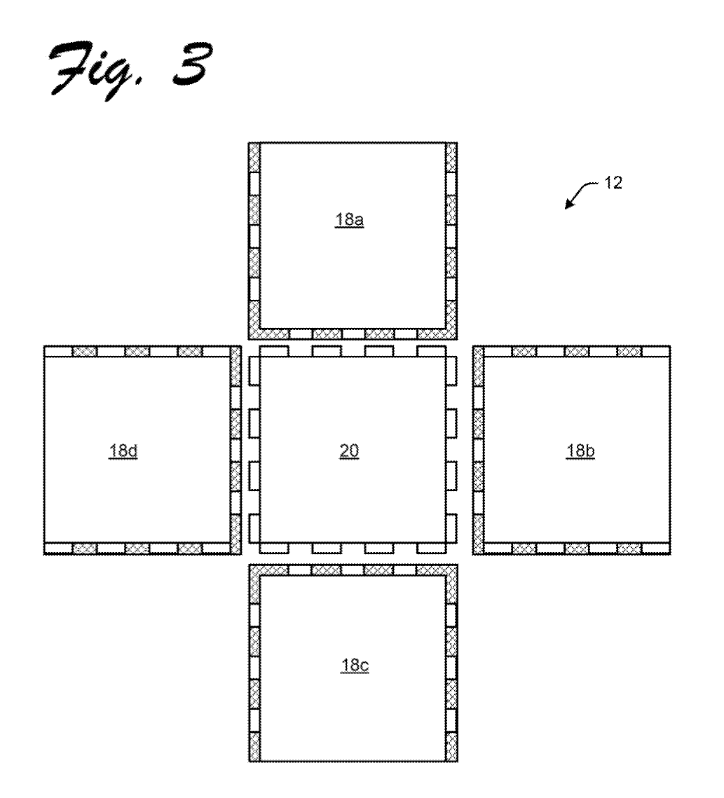

FIG. 2 shows example skins 16a-f which may appear on a visible outer layer 14 of the configurable wall 10. By way of example, skin 16a depicts a brick design, skin 16b depicts a wood design, skin 16c depicts a marble design, skin 16d depicts a lattice design, and skins 16e-f depict stone designs. Other depictions are also contemplated and are not limited to those shown in FIG. 2. For example, seasonal themes, gender themes (for a boys room or girls room), different colors, and other depictions may also be used.

It is noted that the skins may be a part of the sidewalls and/or removably attached to the sidewalls. In an example where the skins are attached to the sidewalls, adhesive (permanent or non-permanent), buttons, snaps, Velcro, or other connectors may be used to attach the skins to the sidewalls. Such an implementation allow the user to change the look and appearance of the wall 10 by using different skins at different times, without having to replace the modules. For example, the user may desire a different look in the summer months than in the winter months. Or for example, the user may replace damaged or weathered skins without having to replace the entire module and/or wall.

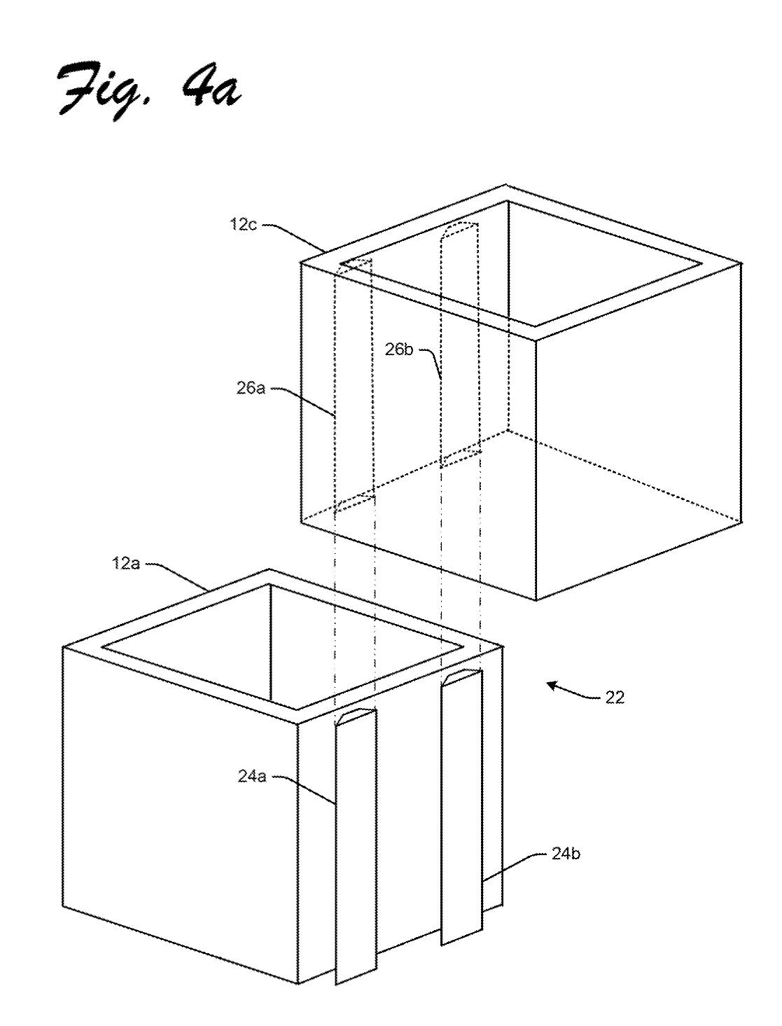

The wall 10 shown in FIG. 1 includes a plurality of hollow-formed modules 12a-c, each having an outer layer selected to compliment the outer layer of the other modules. The modules 12a-c may be assembled from a plurality of side wall. FIG. 3 is a plan view of an example unassembled module 12 used in the configurable wall 10. The unassembled module 12 shown in FIG. 3 includes four sidewalls 18a-d. It is noted, however, that fewer sidewalls may also be used. The unassembled module 12 also includes a bottom portion 20. A top portion (not shown) and the bottom portion 20 are not required in all implementations.

In an example, the sidewalls 18a-d are universal and interchangeable. That is, the sidewalls 18a-d may be connected to any of the other sidewalls and also in any number of different modules 12a-c. As shown, the sidewalls 18a-d include interlocking fingers, or male/female connecting portions. Other connections are also contemplated, however, the interlocking configuration provides ease of assembly for the layperson and may be readily assembled without use of separate hardware (e.g., connected with an interference fit).

It is noted that in the unassembled view shown in FIG. 3, the sidewalls and bottom of modules 12a-c lay relatively flat and can be readily stacked and packaged for shipping. This also makes the walls lightweight and readily transported by the consumer (e.g., in the trunk of an automobile, or in the elevator of an apartment building).

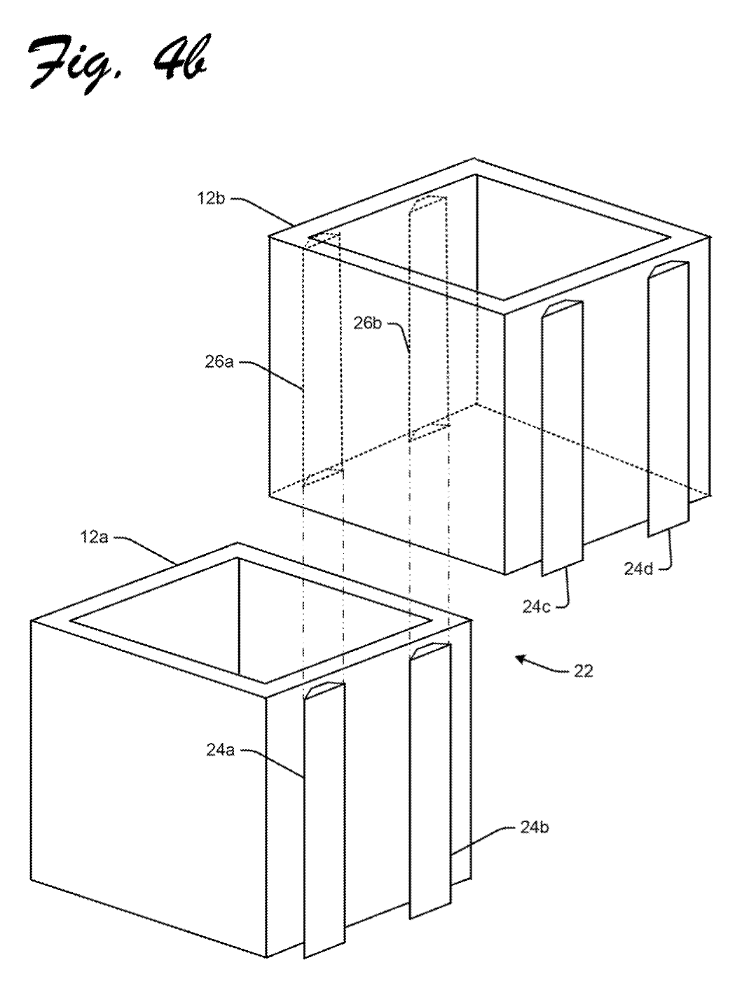

The wall 10 also includes an interconnect system 22 to secure the modules 12a-c together. FIG. 4a illustrates example assembly of adjacent modules 12a and 12c to form a two-module wide wall, and FIG. 4b illustrates where another module (e.g., module 12c in FIG. 1) may be assembled to module 12b to form a three-module wide wall using tongues 24c-d. Of course, the wall is not limited to two-module and three-module configurations. It can be seen that many different assemblies produce a wide variety of different configurations of the wall 10 using the universal and modular nature of the components described herein.

In this example, the interconnect system 22 includes tongue and groove components. That is, the tongue(s) 24a-b are formed on a sidewall of the first module 12a, and the mating groove(s) 26a-b are formed on a sidewall of the second module 12b. Of course the interconnect system 22 is not limited to such an implementation. Indeed, the sidewall may include both tongues and grooves, a single tongue and groove may be used, or multiple and different types of tongue and grooves may be used.

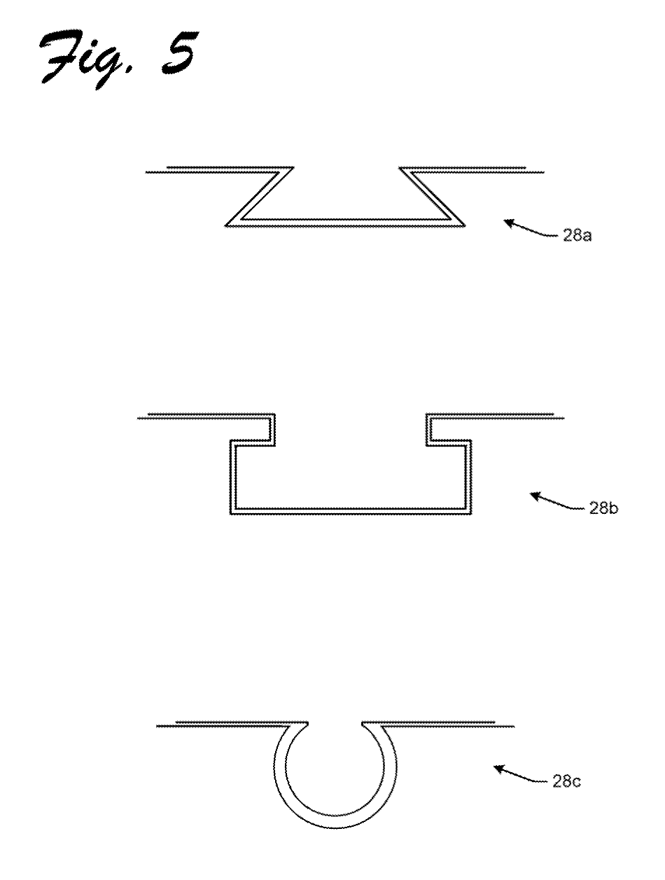

FIG. 5 shows cross-sectional views of example interlocking members for assembling adjacent modules. In this example, 28a shows a trapezoidal tongue and groove, 28b shows a rectangular tongue and groove, and 28c shows a circular tongue and groove. Of course the interlocking members are not limited to tongue and groove configurations, and other interconnects may also be used.

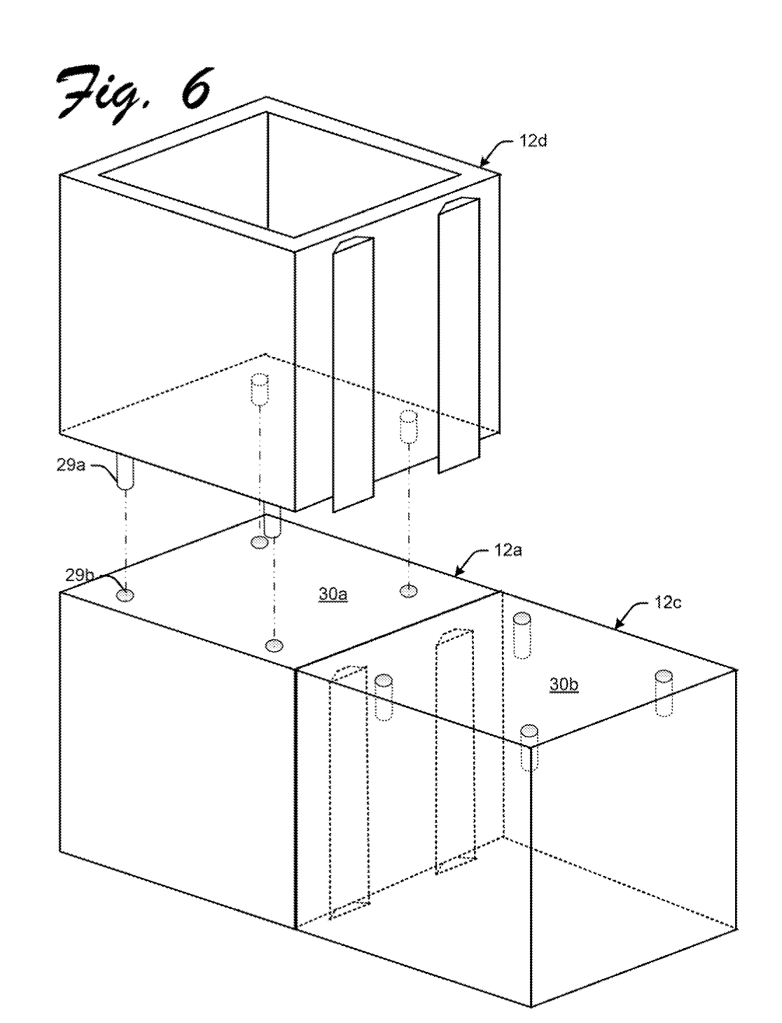

FIG. 6 is another illustration of assembly of adjacent modules (e.g., modules 12a and 12c are shown adjacent another with a module 12d stacked on top of module 12a) to form the configurable wall. In this example, the modules 12a-c are stackable one on top of another and also adjacent one another using pegs 29a that fit into holes 29b, although other connectors may be utilized. This example also shows modules 12a and 12b having a top portion 30a and 30c, respectively.

Before continuing, it is noted that the configurable wall is not limited in function. The configurable wall may be used as planter boxes. However, the configurable wall may also be used for other purposes, such as room dividers or other interior and/or exterior decoration.

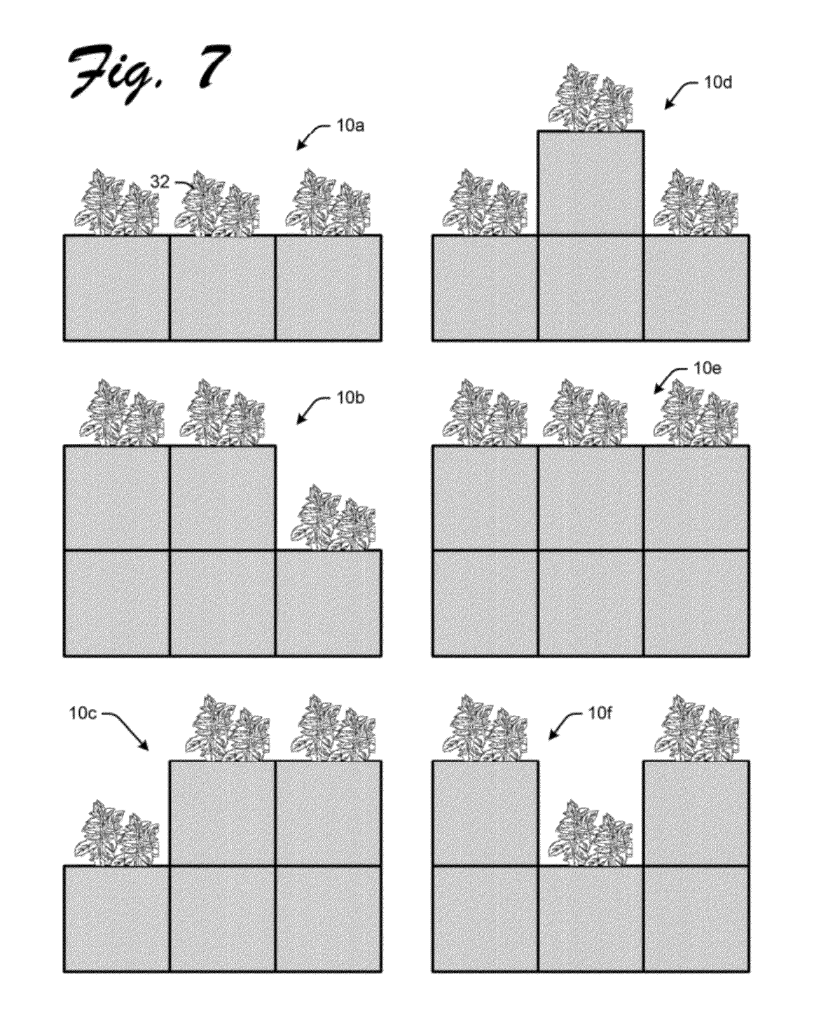

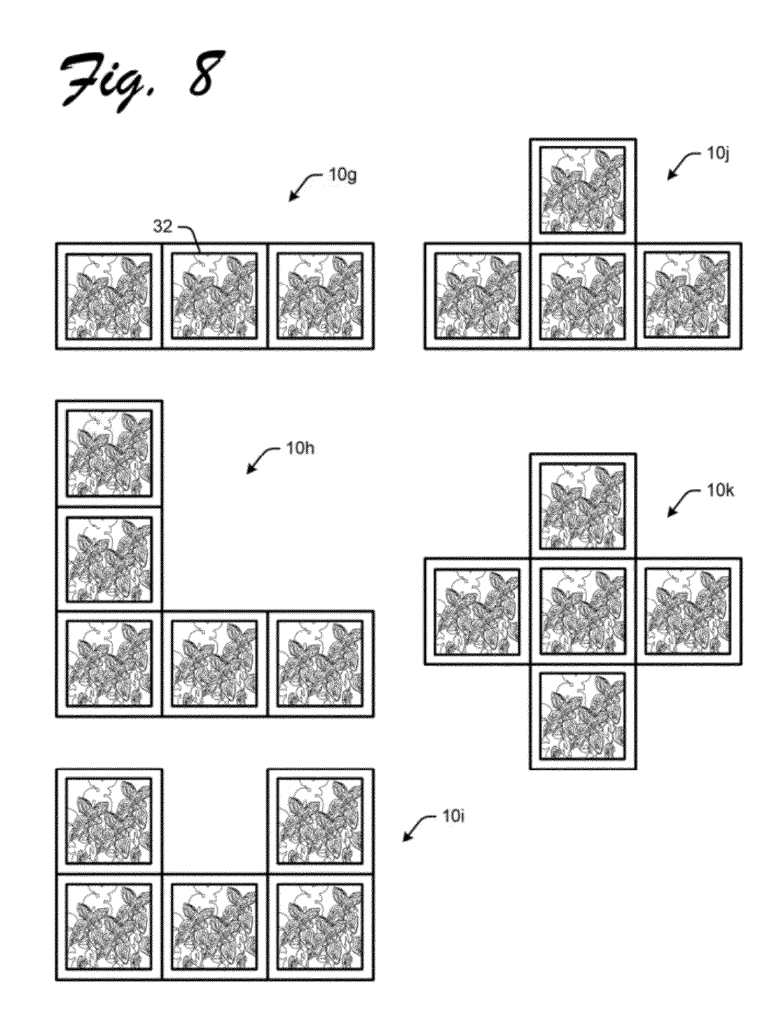

FIG. 7 are side plan views showing example configurations 10a-f of the configurable wall. A plant 32 is illustrated in these examples, although it is noted that the wall is not limited to any particular function (e.g., as a planter box). The plant 32 is only labeled once in the drawings for purposes of clarity, although it can be seen in each of the configurations for purposes of illustration. FIG. 8 are top plan views showing example configurations 10g-k of the configurable wall. Again, plant 32 is illustrated in these examples, although it is noted that the wall is not limited to any particular function (e.g., as a planter box). The plant 32 is only referenced once in the drawings for purposes of clarity, although it can be seen in each of the configurations for purposes of illustration.

It is noted that the examples described above are provided for purposes of illustration, and are not intended to be limiting. Other components may be utilized. In addition, the configurations are shown to illustrate examples. The configurations are not limited to those shown in the drawings. Still other configurations may also be implemented.

Again, the examples shown and described are provided for purposes of illustration and are not intended to be limiting. Still other examples are also contemplated.

1. A configurable wall, comprising:
a first hollow-formed module having an outer layer selected to portray a material of manufacture which is substantially different than a material with which the first hollow-formed module is manufactured;
a second hollow-formed module having an outer layer selected to compliment the outer layer of the first hollow-formed module; and
an interconnect to secure the first module and the second module together.

2. The configurable wall of claim 1, wherein the first module has interchangeable sidewalls and a bottom wall.

3. The configurable wall of claim 2, wherein at least one of the interchangeable sidewalls includes a portion of the interconnect.

4. The configurable wall of claim 1, wherein the first and second modules each include a portion of the interconnect formed as part of a sidewall thereof.

5. The configurable wall of claim 1, wherein the interconnect is a tongue and groove mechanism.

6. The configurable wall of claim 1, further comprising at least a third module having an outer layer selected to compliment the outer layer of the first and second hollow-formed modules, and wherein at least the third module interlocks with at least one of the first and second modules.

7. The configurable wall of claim 1, further comprising a plurality of sidewalls, each sidewall universally connectable with any of the other sidewalls to assemble multiple configurations of the modules.

8. The configurable wall of claim 7, wherein the plurality of sidewalls lay flat and are stackable.

9. The configurable wall of claim 1, wherein the outer layer of the modules is a removable skin.

10. The configurable wall of claim 1, wherein the outer layer has a faux finish.

11. The configurable wall of claim 10, wherein the faux finish is selected from stone, lattice, wood, and brick.

12. The configurable wall of claim 10, wherein the modules are stackable one on top of another.

13. The configurable wall of claim 10, wherein the modules are stackable in a side-by-side configuration.

14. A configurable decorative wall, comprising:
a first hollow-formed module having an outer layer with a faux finish depicting a material of manufacture different than a material that the first hollow-formed module is actually manufactured from;
at least a second hollow-formed module having an outer layer complimenting the outer layer of the first hollow-formed module, wherein each of the modules are assembled from a plurality of universally interchangeable side walls; and
an interconnect to secure the first module and the second module together.

15. The configurable decorative wall of claim 14, wherein the modules are stackable one on top of another and wherein the modules are stackable in a side-by-side configuration.

16. The configurable decorative wall of claim 10, wherein the plurality of sidewalls when unassembled lay flat and are stackable.

17. The configurable decorative wall of claim 10, wherein at least one of the interchangeable sidewalls of adjacent modules each includes a portion of the interconnect.

18. The configurable wall of claim 1, wherein the sidewalls are universally connectable with any of the other sidewalls to assemble the modules in different configurations.

19. The configurable wall of claim 1, wherein the modules are connected together to form a planter.

20. A method of assembling a configurable wall, comprising:
assembling a first module from a plurality of interchangeable side walls, wherein visible side walls of the first module have an outer layer with a faux finish;
assembling at least a second module from a plurality of interchangeable side walls, wherein visible side walls of the second module having an outer layer with a faux finish complimenting the outer layer of the first module; and
interconnecting the modules to form the configurable wall.
